(19) United States
(12) Patent Application Publication
(10) Pub. No.: US 2002/0006502 A1
(43) Pub. Date: Jan. 17, 2002

(54) STAPLE FIBER NON-WOVEN FABRIC AND PROCESS FOR PRODUCING THE SAME

(76) Inventors: KOUICHI NAGAOKA, OSAKA (JP); ATSUSHI MATSUNAGA, OKAZAKI-SHI (JP); NORIKO YOSHIDA, OKAZAKI-SHI (JP)

Correspondence Address: LINDA M DESCHERE, YOUNG & BASILE, 3001 WEST BIG BEAVER ROAD, SUITE 624, TROY, MI, 48084

(21) Appl. No.: 09/236,718

(22) Filed: Jan. 25, 1999

(30) Foreign Application Priority Data
Jan. 30, 1998 (JP) 10-17610

(51) Int. Cl. B32B 27/14; B32B 5/16; B32B 5/26; D04H 1/00

(52) U.S. Cl. 428/198; 428/374; 442/284

(57) ABSTRACT

A staple fiber non-woven fabric is provided which comprises, as constituent fibers, first and second split staple fibers composed of first and second fiber formable polymers, respectively, and water-absorptive staple fibers. The first and second split staple fibers have a fineness of not greater than 0.5 denier per fiber. The first and second fiber formable polymers are different polymers selected from the group consisting of a polyamide, a polyester and a polyethylene which are incompatible with each other. The fiber split degree of the first and second split staple fibers is not lower than 85%. The constituent fibers are three-dimensionally entangled with each other.

### FIELD OF THE INVENTION

The present invention relates to a staple fiber non-woven fabric and a process for producing the same.

### BACKGROUND OF THE INVENTION

Spunlaced non-woven fabrics produced by three-dimensionally entangling constituent fibers by the action of high pressure liquid streams are used for a variety of applications because of their excellent softness. Used as materials for such non-woven fabrics are natural fibers and synthetic fibers, depending on the applications thereof.

For example, JP-A-62-268861 (1987) discloses a non-woven fabric produced by such a method that conjugate filaments are partially fibrillated when crimps are imparted to the filaments in a drawing process and liquid streams are applied to constituent fibers for promotion of the fibrillation and for entanglement of the constituent fibers. The resulting non-woven fabric is highly soft because it is composed of micro-denier fibers. However, the non-woven fabric is not suitable for use in a wet or moistened state, since the constituent fibers are made of a polymer having a poor water absorbing property.

To overcome this drawback, JP-A-6-101148 (1994) discloses a spunlaced non-woven fabric for a wiper which comprises micro-denier split staple fibers of not greater than 0.5 denier and cotton or rayon fibers as a hydrophilic fibrous constituent. The non-woven fabric is highly soft with draping property and, therefore, suitable for cleaning precision instruments and the like without any damages thereto. In addition, the non-woven fabric has wiping and water absorbing properties.

One fibrous component of the split staple fibers in the non-woven fabric disclosed in JP-A-6-101148 is composed of polypropylene. Since a polypropylene-containing filament cannot satisfactorily be quenched at melt-spinning thereof, the filament is likely to be sticky before drawing thereof. As a result, the drawability of the filament is impaired, making it difficult to obtain the intended split staple fibers. Further, the water absorbing property of the fibers is not satisfactory. In addition, a difference in compatibility index between the polypropylene fibrous component and another fibrous component of polyester is relatively great, so that the filament is liable to be fibrillated before a splitting process. This presents a problem in card passage, resulting in an unsatisfactory operability.

### SUMMARY OF THE INVENTION

It is an object of the present invention to solve the aforesaid problems and to provide a non-woven fabric which is superior in water absorbing property, mechanical properties, softness, air permeation resistant property and operability, and can be used for wiping, filtering and the like in a wide variety of application fields.

In accordance with one aspect of the present invention for achievement of the aforesaid object, there is provided a staple fiber non-woven fabric which comprises, as constituent fibers, first and second split staple fibers composed of first and second fiber formable polymers, respectively, and obtained by splitting splittable bicomponent conjugate staple fibers composed of the first and second fiber formable polymers, and water-absorptive staple fibers, wherein the first and second split staple fibers have a fineness of not greater than 0.5 denier per fiber, wherein the first and second fiber formable polymers are different polymers selected from the group consisting of a polyamide, a polyester and a polyethylene which are incompatible with each other, wherein a fiber split degree of the first and second split staple fibers is not lower than 85%, wherein the constituent fibers are three-dimensionally entangled with each other.

In accordance with another aspect of the present invention, there is provided a process for producing a staple fiber non-woven fabric, which comprises the steps of: spinning splittable bicomponent conjugate staple fibers composed of first and second fiber formable polymers which are different polymers selected from the group consisting of a polyamide, a polyester and a polyethylene which are incompatible with each other; forming a non-woven web by blending the splittable bicomponent conjugate staple fibers with water-absorptive staple fibers; and subjecting the non-woven web to a high pressure liquid stream treatment, whereby the conjugate staple fibers are split at a fiber split degree of not lower than 85% into first split staple fibers composed of the first fiber formable polymer and having a fineness of not greater than 0.5 denier per fiber and second split staple fibers composed of the second fiber formable polymer and having a fineness of not greater than 0.5 denier per fiber, and the first and second split staple fibers and the water-absorptive staple fibers are three-dimensionally entangled with each other.

In accordance with the present invention, the first and second split staple fibers are composed of different polymers selected from the group consisting of a polyamide, a polyester or a polyethylene, so that the quenching at the melt spinning is satisfactory and the split staple fibers are superior in heat stability. Since the non-woven fabric contains the water-absorptive staple fibers and the first and second split staple fibers having a fineness of not greater than 0.5 denier per fiber with a fiber split degree of not lower than 85%, the non-woven fabric is superior in softness and water absorbing property. In addition, the constituent fibers of the non-woven fabric are three-dimensionally and densely entangled with each other, because the first and second split staple fibers have a fineness of not greater than 0.5 denier per fiber with a fiber split degree of not lower than 85%. Therefore, the non-woven fabric is soft and superior in mechanical properties. Accordingly, the non-woven fabric provided by the present invention can be used for wipers, filters, hygienic products such as sanitary napkins and disposable diapers, and the like in a wide variety of application fields. Particularly where the non-woven fabric is used for the hygienic products, superior liquid absorbing properties can be ensured by synergy of the water absorbing effects offered by the hydrophilic nature of the water-absorptive staple fibers and by the three-dimensional entanglement of the split staple fibers of not greater than 0.5 denier. In addition, the split staple fibers are effective to rapidly diffuse liquid hydrophilically absorbed by the water-absorptive staple fibers within the non-woven fabric. Therefore, the non-woven fabric is capable of absorbing a greater amount of liquid when used for the hygienic products.

### BRIEF DESCRIPTION OF THE DRAWING

FIG. 1 is a diagram illustrating one exemplary cross-sectional configuration of each splittable bicomponent conjugate fiber constituting a non-woven fabric of the present invention.

### DESCRIPTION OF THE PREFERRED EMBODIMENTS

Splittable bicomponent conjugate staple fibers constituting a non-woven fabric of the present invention are composed of first and second fiber formable polymers which are incompatible with each other. The incompatibility of the first and second fiber formable polymers allows the conjugate staple fibers to easily split when a high pressure liquid stream treatment is performed to apply impacts to the conjugate staple fibers.

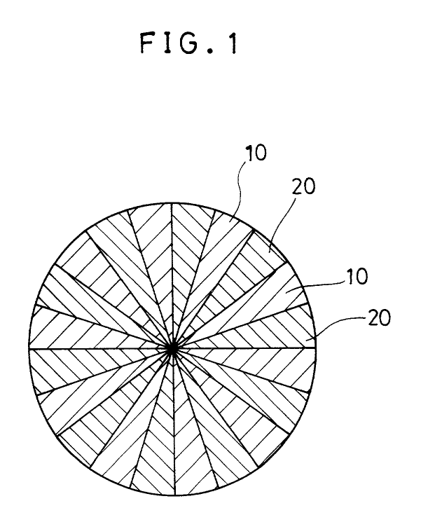

The splittable bicomponent conjugate staple fibers each have a cross-sectional configuration as shown in FIG. 1, for example, and include plural segments 10 of the first fiber formable polymer and plural segments 20 of the second fiber formable polymer which are circumferentially arranged in an alternating relation. The splittable bicomponent conjugate staple fibers having such a configuration are split at interfaces of the polymeric segments 10 and 20 into split staple fibers comprised of the polymeric segments 10 and 20 and having a fineness of not greater than 0.5 denier per fiber, when impacts are applied to the conjugate staple fibers during a fiber splitting process after spinning.

For formation of the staple fibers of not greater than 0.5 denier per fiber, it is preferred that the number of the circumferentially arranged splittable segments be 4 to 24 on the precondition that the conjugate staple fibers having the cross-sectional configuration shown in FIG. 1 have a fineness of 2 to 12 denier per fiber. If the number of the circumferentially arranged segments is increased, smaller-denier split staple fibers can be formed. However, an upper limit of the number of the splittable segments is about 36 because of limitations on spinneret design and the like.

If the single fiber fineness of the conjugate staple fibers is smaller than 2 denier, the productivity tends to be reduced. The productivity may be improved by using a greater number of spinnerets, but an unstable spinning process may result. On the other hand, if the single fiber fineness is greater than 12 denier, a melt-spun filament cannot sufficiently be quenched. This makes it difficult to take up the filament at the spinning. The quenching of the filament may be promoted by using a smaller number of spinnerets, but the productivity is reduced.

If the single fiber fineness of the split staple fibers is greater than 0.5 denier, it is difficult to three-dimensionally and densely entangle the constituent fibers for non-woven fabric formation, thereby failing to obtain the non-woven fabric intended by the present invention. Therefore, it is particularly preferred that the single fiber fineness is not greater than 0.3 denier.

The first and second fiber formable polymers constituting the splittable bicomponent conjugate staple fibers are different polymers selected from the group consisting of a polyamide, a polyester and a polyethylene which are incompatible with each other. Three combinations of the first and second fiber formable polymers are possible, i.e., a polyamide and a polyester, a polyamide and a polyethylene, and a polyester and a polyethylene.

Examples of specific polyamides include polyimino-1-oxotetramethylene (nylon 4), polytetramethylene adipamide (nylon 46), polycapramide (nylon 6), polyhexamethylene adipamide (nylon 66), polyundecanamide (nylon 11), polylaurolactamide (nylon 12), poly-m-xylene adipamide, poly-p-xylylene decanamide and polybiscyclohexylmethane decanamide, and polyamide copolymers containing a monomer of any of these polymers as a monomeric unit. Particularly, a copolymer of polytetramethylene adipamide (nylon 46) may be employed which is obtained by copolymerizing polytetramethylene adipamide (nylon 46) with not greater than 30 mol % of another polyamide component such as polycapramide, polyhexamethylene adipamide or polyundecamethylene terephthalamide.

Examples of specific polyesters include homopolymers and copolymers of esters comprised of acid components of aromatic dicarboxylic acids such as terephthalic acid, isophthalic acid, phthalic acid and naphthalene-2,6-dicarboxylic acid, aliphatic dicarboxylic acids such as adipic acid and sebacic acid, and esters of these acids, and alcohol components of diols such as ethylene glycol, diethylene glycol, 1,4-butanediol, neopentyl glycol and cyclohexane-1,4-dimethanol. Further, p-hydroxybenzoic acid, 5-sodiumsulfoisophthalic acid, polyalkylene glycol, pentaerythritol, bisphenol A or the like may be added to or copolymerized with any of these polyesters.

Examples of specific polyethylenes include linear low-density polyethylenes, medium-density polyethylenes and high-density polyethylenes. These polyethylenes preferably have melt index values of 10 to 80 g/10 minutes as measured in conformity with the method of ASTM-D-1238E. If the melt index value is lower than 10 g/10 minutes, the melt viscosity is too high, resulting in an inferior spinnability. If the melt index value exceeds 80 g/10 minutes, the melt viscosity is too low, resulting in slipperiness of the resulting fibers. In addition, the quenching of a spun filament is unsatisfactory, resulting in stickiness of the filament. These polyethylenes may be copolymerized with not greater than 10 wt % of any of various similar unsaturated ethylene-type monomers such as butadiene, isoprene, 1,3-pentadiene, styrene and α-methylstyrene, or copolymerized with not greater than 10 wt % of propylene, 1-butene, 1-octene, 1-hexene or a similar higher α-olefin, based on the amount of ethylene.

Any of various additives such as a delustering agent, a pigment, a flame retardant, a deodorant, an anti-static agent, photo-stabilizer, a heat stabilizer, an anti-oxidant and an anti-fungus agent may be added, as required, to these polymers as long as the effects of the present invention are not impaired.

It is necessary that the fiber split degree of the first and second split staple fibers be not lower than 85%. If the fiber split degree is lower than 85%, the greater-denier splittable bicomponent staple fibers remain unsplit in a higher proportion. Therefore, the resulting product, when used for wiping or filtering, has an inferior wiping or filtering property. For this reason, it is further preferred that the fiber split degree be not lower than 90%.

The water-absorptive staple fibers preferably have an official moisture regain of not lower than 5%. Examples of the fibers having an official water regain of not lower than 5% include natural fibers such as cotton, pulp, hemp, wool and silk cut in a staple form. Also usable as the water-absorptive staple fibers are regenerated fibers such as viscose rayon obtained from pulp, cuprammonium rayon and solution-spun rayon (available under the registered trade name of LYOCEL), and synthetic fibers such as vinylon fibers and acrylic fibers which have an official water regain of not lower than 5%. Two or more types of these fibers may be blended for use as the water-absorptive staple fibers.

The non-woven fabric of the present invention preferably contains the water-absorptive staple fibers in a proportion of 30 to 70 wt %. The presence of the water-absorptive staple fibers in a proportion of not lower than 30 wt % imparts satisfactory water absorbing and water retaining properties to the non-woven fabric. Such a non-woven fabric is suitable for garments having excellent sweat absorbing properties and for wipers having excellent water wiping properties. If the proportion of the water-absorptive staple fibers exceeds 70 wt %, the resulting non-woven fabric has sufficient water absorbing and water retaining properties, but the constituent fibers thereof may be less densely entangled because the micro-denier split staple fibers are present in a smaller proportion. Therefore, such a non-woven fabric has an excessively high breathability and, hence, tends to exhibit a reduced heat retaining effect or to have inferior dust and dirt trapping properties when used as a filter or a wiper.

The weight per unit area of the non-woven fabric of the present invention is preferably 30 to 150 g/m². If the weight per unit area is less than 30 g/m², the resulting non-woven fabric is poor in applicability, shape stability and dimension stability because of its inferior mechanical strength. On the other hand, a weight per unit area of greater than 150 g/m² is not preferable in terms of economy, because a greater working energy is required for a high pressure liquid stream treatment (which will be described later) for three dimensional entanglement of the constituent fibers. Further, the weight per unit area exceeding 150 g/m² leads to insufficient fiber entanglement in the non-woven fabric in some cases, so that the non-woven fabric is liable to exhibit a lower mechanical strength. In addition, the splittable bicomponent conjugate staple fibers cannot sufficiently be split, so that the non-woven fabric tends to be less soft.

Next, a process for producing the non-woven fabric of the present invention will be described.

An explanation will first be given to a process for producing the splittable bicomponent conjugate staple fibers. The aforesaid two types of fiber formable polymers which are incompatible with each other are melted individually, and melt-spun with the use of a spinneret which is designed to provide the splittable conjugate cross-sectional configuration shown in FIG. 1. In turn, a spun filament is quenched with a cooling air flow by means of a conventionally known quenching device adapted for lateral air blowing or annular air blowing. Thereafter, an oil is applied to the filament, which is then wound up as an unstretched filament via a take-up roller by a wind-up machine. The take-up rate of the take-up roller is preferably 500 m/min to 2000 m/min. A plurality of unstretched filaments thus wound up are bundled into a tow, which is drawn between a plurality of rollers being rotated at different circumferential speeds in a known drawing machine. Subsequently, the drawn tow is imparted with crimps by means of a squeeze-type crimping machine and, after application of a spinning fat, cut to a predetermined fiber length into staple fibers. The drawn tow may be heat-set at a temperature of not higher than the melting points of the fiber materials in accordance with intended applications of the non-woven fabric.

Then, the splittable bicomponent conjugate staple fibers thus obtained are blended with the water-absorptive staple fibers in a weight ratio of 70/30 to 30/70 (wt %) by a carding method or an air-laying method for formation of a non-woven web having a predetermined weight per unit area. At this time, where the carding method is employed, the arrangement of the constituent fibers can be variably controlled in accordance with the intended applications of the non-woven fabric with the use of a carding machine. If the non-woven fabric is to be used for garments, for example, the non-woven web is formed so that the resulting non-woven fabric can have a length-to-width strength ratio of generally 1:1. Exemplary arrangement patterns of the constituent fibers of the non-woven web include a parallel web pattern in which constituent fibers are unidirectionally arranged, a cross-laid web pattern in which parallel webs are cross-laid, a random web pattern in which constituent fibers are arranged at random, and a semi-random web pattern which is a hybrid between the aforesaid web patterns.

Subsequently, the non-woven web thus obtained is subjected to the high pressure liquid stream treatment, whereby the splittable bicomponent conjugate staple fibers are split into the first split staple fibers of the first fiber formable polymer and the second split staple fibers of the second fiber formable polymer. At the same time, the constituent fibers including the water-absorptive staple fibers in the entire web are three-dimensionally entangled with each other. The three-dimensional entanglement herein means that the constituent fibers of the non-woven web are entangled not only along the length and width but also across the thickness of the non-woven fabric for formation of an integral structure.

In the high pressure liquid stream treatment, an orifice head is employed which has a multiplicity of orifices arranged at intervals of 0.05 to 5 mm in a row or plural rows and each having a diameter of 0.05 to 1.5 mm, particularly 0.1 to 0.4 mm. High pressure liquid streams ejected from the orifice head impact on the non-woven web on a perforated support base, whereby the splittable bicomponent staple fibers are split at interfaces of segments of the first and second polymers into first split staple fibers of not greater than 0.5 denier composed of the first polymer and second split staple fibers of not greater than 0.5 denier composed of the second polymer. At the same time, the impact of the high pressure liquid streams generates a force that squeezes some of the constituent fibers into the web, and twists, bends and rotates other surrounding fibers. Thus, the constituent fibers are three-dimensionally entangled with each other for integration thereof. The mutual entanglement of the fibers is densified and strengthened by the presence of the micro-denier split staple fibers of not greater than 0.5 denier, so that a soft non-woven fabric is obtained.

The orifices of the orifice head are arranged in a row or rows extending perpendicularly to a transport direction of the non-woven web. Water or hot water can be used for the high pressure liquid streams. The non-woven web is spaced by a distance of 10 to 150 mm from the orifices. If the distance is smaller than 10 mm, a non-woven fabric resulting from such a treatment has a disordered texture. If the distance is greater than 150 mm, an impact force of the liquid streams on the non-woven web is reduced, making it difficult to effect sufficient fiber splitting and three-dimensional entanglement.

The ejection pressure of the high pressure liquid streams is controlled on the basis of required properties of the non-woven fabric, and is typically 20 to 200 kg/cm²G, preferably 80 to 150 kg/cm²G. A relatively low treatment pressure provides a bulky and soft non-woven fabric though depending on the weight per unit area and the like of the non-woven web to be treated. A relatively high treatment pressure allows for dense entanglement of the constituent fibers, thereby providing a highly strong non-woven fabric having an excellent filtering property. If the ejection pressure is lower than 20 kg/cm²G, the fiber splitting and the entanglement for integration of the constituent fibers cannot sufficiently be effected so that the resulting non-woven fabric has a lower mechanical strength. A fiber split degree of not lower than 85% will suffice and, even if some of the splittable bicomponent conjugate staple fibers remain unsplit, there is practically no problem. On the other hand, an ejection pressure of higher than 200 kg/cm²G is not preferable, because the constituent fibers are cut off by the water pressure impact in an extreme case so that the resulting non-woven fabric tends to have a fluffy surface.

The perforated support base which supports the non-woven web during the high pressure liquid stream treatment is not particularly limited as long as the high pressure liquid streams can pass through the non-woven web and the support base. Examples of the perforated support base include a mesh screen such as a 20- to 200-mesh wire net and a perforated plate. The mesh screen is typically of not smaller than 50 mesh, preferably of not smaller than 70 mesh, so as not to leave a wire net mark on the non-woven fabric. An emboss pattern can optionally be formed on the non-woven fabric by selecting a mesh screen having a desired netting pattern, apertures and the like.

After one side of the non-woven web is subjected to the high pressure liquid stream treatment, the non-woven web is turned upside down for high pressure liquid stream treatment on the other side thereof. Thus, the constituent fibers on the opposite sides of the resulting non-woven fabric are densely entangled. Therefore, it is particularly preferred that the two-side high pressure liquid stream treatment be applied to a non-woven web of a greater weight per unit area in accordance with the applications of the non-woven fabric.

After the high pressure liquid stream treatment, excess water is removed from the non-woven web. Any of known methods may be employed for the removal of the excess water. For example, the excess water removal is achieved by mechanically removing the excess water to some extent by means of a squeezer such as a mangle roll and then removing the residual water by means of a drier such as a hot air circulation drier of suction band type.

### EXAMPLES

The present invention will more specifically be described on the basis of experimental examples. However, it should be understood that the invention be not limited to these examples.

In the examples described below, physical properties were determined in the following manner.

(1) Melting point (° C.) of polymer: The measurement was carried out at a temperature rise rate of 20° C./min with the use of a differential scanning calorimeter of DSV-2 model available from Perkin Elmer Company. A temperature which gave an extreme value in the resulting fusion-endotherm curve was determined as a melting point.

(2) Melt index (g/10 minutes): The measurement was carried out in conformity with the method specified in ASTM-D-1238(E).

(3) Melt flow rate (g/10 minutes): The measurement was carried out in conformity with the method specified in ASTM-D-1238(L).

(4) Relative viscosity: 0.5 g of a test sample was dissolved in 100 cc of a solvent mixture containing phenol and tetrachloroethane in a weight ratio of 1:1, and the measurement was carried out at a temperature of 20° C. in accordance with an ordinary method.

(5) Relative viscosity of polyamide: 1 g of a test sample was dissolved in 100 cc of 96 wt % sulfuric acid, and the measurement was carried out at a temperature of 25° C. in accordance with an ordinary method.

(6) Weight per unit area (g/m²) of non-woven fabric: Five specimens of 10 cm×10 cm (length×width) were prepared from a test sample in standard conditions. The specimens, after having been allowed to reach an equilibrium moisture regain, were each weighed in a unit of gram. The weight values thus obtained were averaged, and converted on the basis of unit area (m²) for determination of the weight per unit area (g/m²) of the non-woven fabric.

(7) KSGM tensile strength (kg/5 cm width) of non-woven fabric: A peak tensile strength was measured in accordance with the strip method specified in JIS-L-1096. More specifically, ten specimens of 5 cm×15 cm (width×length) were prepared for determination of the machine direction (MD) tensile strength and for determination of the cross-machine direction (CD) tensile strength. The peak tensile strength of each of the specimens was measured at a stretching rate of 10 cm/min with a specimen grab spacing of 10 cm by means of a tensile tester of constant rate stretching type (available under the trade name of Tensilon UTM-4-1-100 from Orientec Company). The tensile strengths thus measured for the ten specimens were averaged, and converted on the basis of weight per unit area (100 g/m²) for determination of the KSGM strength (kg/5 cm width) of the non-woven fabric.

(8) Anti-compression rigidity (g): Five specimens of 5 cm×10 cm (width×length) were prepared, and longitudinally rolled into a cylindrical form with longitudinally opposite ends thereof bonded to each other for preparation of test samples for the anti-compression rigidity test. In turn, the test samples were each compressed at a compression rate of 5 cm/min by means of a tensile tester of constant rate stretching type (available under the trade name of Tensilon UTM-4-1-100 from Orientec Company). Obtained peak load values (g) were averaged for determination of the anti-compression rigidity (g).

(9) Breathability (cc/cm²/sec): The measurement was carried out in conformity with the Frazir method specified in JIS-L-1096.

(10) Water absorbing property (mm/10 minutes): The measurement was carried out in conformity with the Bireck method specified in JIS-L-1096.

### Example 1

Polyethylene terephthalate (melting point: 256° C., relative viscosity: 1.38) and nylon 6 (melting point: 225° C., relative viscosity: 2.55) were used as the first fiber formable polymer and the second fiber formable polymer, respectively. Splittable bicomponent staple fibers were prepared from the first and second fiber formable polymers as having a cross-sectional configuration similar to that shown in FIG. 1 with ten segments of the first and second fiber formable polymers radially arranged in an alternating relation.

More specifically, polyethylene terephthalate and nylon 6 were individually melted at temperatures of 285° C. and 265° C., respectively, and extruded in a conjugate weight ratio of 1:1 at a single orifice throughput of 0.65 g/min through a splittable bicomponent conjugate type spinneret which was designed to provide a splittable bicomponent conjugate filament having a cross-sectional configuration similar to that shown in FIG. 1 for spinning. After the spun filament was quenched by a known quenching machine, a finishing oil was applied to the filament. Then, the filament was wound up as an unstretched filament at a take-up rate of 1000 m/min via a take-up roll. In turn, a plurality of unstretched filaments thus obtained were bundled into a tow, and drawn at a draw ratio of 3.1 by means of a known drawing machine having rollers of different circumferential speeds. Thereafter, the tow was imparted with crimps by means of a squeeze-type crimping machine, and then cut to a fiber length of 38 mm into 2-denier conjugate staple fibers.

Bleached cotton fibers having an average fineness of 1.5 denier and an average fiber length of 24 mm were prepared as the water-absorptive staple fibers.

The splittable bicomponent conjugate staple fibers and the water-absorptive staple fibers were blended in proportions of 30 wt % and 70 wt %, respectively, and formed into a 50 g/m² non-woven web by means of a random carding machine.

In turn, the non-woven web was placed on a moving metal mesh screen of 100 mesh, and subjected to the high pressure liquid stream treatment. A high pressure liquid stream apparatus having 0.12-mm diameter orifices arranged at intervals of 0.62 mm in three rows was employed for the high pressure liquid stream treatment. High pressure liquid streams were applied to the non-woven fabric from a position 50 mm above the non-woven fabric at a liquid pressure of 70 kg/cm²G. Excess water was removed from the resulting non-woven fabric by means of a mangle, and the non-woven fabric is dried at 100° C. by means of a drier. Thus, the non-woven fabric of Example 1 was obtained.

As a result of microscopic observation of the obtained non-woven fabric, it was found that the splittable bicomponent conjugate staple fibers had been split for fibrillation through the high pressure liquid stream treatment, and each of the split staple fibers of polyethylene and the micro-denier split staple fibers of polyethylene terephthalate had a fineness of 0.2 denier per fiber. The fiber split degree was 92%, and the constituent fibers were three-dimensionally entangled with each other.

The non-woven fabric had physical properties as shown in Table 1.

TABLE 1

| | | | | | | | Com. | Com. | Com. | Com. | Com. |
|---|---|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 | Ex. 4 | Ex. 5 |
| Production Conditions | | | | | | | | | | | |
| First fiber formable polymer | PET | PET | PET | PET | PET | N-6 | PET | PET | — | PET | PET |
| Second fiber formable polymer | N-6 | N-6 | N-6 | N-6 | PE | PE | PP | — | — | N-6 | N-6 |
| Cross-sectional configuration of fibers | Multi | Multi | Multi | Multi | Multi | Multi | Multi | Mono | — | Multi | Multi |
| Number of segments | 10 | 10 | 10 | 10 | 10 | 10 | 10 | — | — | 10 | 6 |
| Fineness of first split fiber (denier) | 0.2 | 0.2 | 0.2 | 0.5 | 0.2 | 0.2 | 0.2 | — | — | 0.2 | 0.8 |
| Fineness of second split fiber (denier) | 0.2 | 0.2 | 0.2 | 0.5 | 0.2 | 0.2 | 0.2 | — | — | 0.2 | 0.8 |
| Blend ratio (wt %) | 30/70 | 50/50 | 70/30 | 50/50 | 50/50 | 50/50 | 50/50 | 50/50 | 0/100 | 100/0 | 50/50 |
| Pressure of liquid jet streams (kg/cm²) | 70 | 70 | 70 | 70 | 70 | 70 | 70 | 70 | 70 | 70 | 70 |
| Physical properties of non-woven fabric | | | | | | | | | | | |
| Fiber split degree (%) | 92 | 92 | 92 | 94 | 89 | 85 | 94 | — | — | 92 | 95 |
| Weight per unit area (g/m²) | 50 | 50 | 50 | 50 | 50 | 50 | 50 | 50 | 50 | 50 | 50 |
| KGSM strength (kg/5 cm width) | 28.4 | 30.5 | 31.7 | 24.6 | 28.0 | 27.1 | 28.3 | 16.8 | 14.2 | 32.9 | 20.4 |
| Anti-compression rigidity (g) | 32.3 | 19.1 | 12.8 | 35.8 | 16.1 | 14.2 | 16.3 | 48.4 | 62.2 | 8.5 | 41.7 |
| Breathability (cc/cm²/sec) | 98 | 82 | 65 | 125 | 87 | 90 | 96 | 276 | 175 | 52 | 170 |
| Water absorption (mm/10 min) | 124 | 85 | 67 | 79 | 63 | 84 | 42 | 47 | 165 | — | 58 |

*PET: Polyethylene terephthalate, N-6: Nylon 6, PP: Polypropylene, PE: Polyethylene
*Blend ratio: composite fibers/water-absorptive fibers (wt %)

### Example 2

A non-woven fabric was prepared in substantially the same manner as in Example 1, except that the blending ratio of the splittable bicomponent conjugate staple fibers to the water-absorptive staple fibers was 50/50 (wt %). The non-woven fabric had physical properties as shown in Table 1.

### Example 3

A non-woven fabric was prepared in substantially the same manner as in Example 1, except that the blending ratio of the splittable bicomponent conjugate staple fibers to the water-absorptive staple fibers was 70/30 (wt %). The non-woven fabric had physical properties as shown in Table 1.

### Example 4

Conjugate staple fibers of 5 denier were prepared in substantially the same manner as in Example 2, except that the filament was spun at a single orifice throughput of 1.74 g/min, then drawn at a draw ratio of 3.3, and cut to a fiber length of 51 mm. Then, a non-woven fabric was prepared in the same manner as in Example 2.

As a result of microscopic observation of the non-woven fabric, it was found that the split staple fibers of polyethylene terephthalate and nylon 6 had a fineness of 0.5 denier per fiber. The fiber split degree was 94%, and the constituent fibers were three-dimensionally entangled with each other.

The non-woven fabric had physical properties as shown in Table 1.

### Example 5

Polyethylene terephthalate as used in Example 2 was used as the first fiber formable polymer, and polyethylene (melting point: 130° C., melt index: 20 g/10 minutes) was used as the second fiber formable polymer. Conjugate staple fibers of 2 denier were prepared in substantially the same manner as in Example 2, except that polyethylene was melted at a temperature of 220° C., the single orifice throughput for the spinning was 0.59 g/min, and the draw ratio was 2.8. A non-woven fabric was prepared in the same manner as in Example 2.

As a result of microscopic observation of the non-woven fabric, it was found that the split staple fibers of polyethylene terephthalate and polyethylene had a fineness of 0.2 denier per fiber. The fiber split degree was 89%, and the constituent fibers were three-dimensionally entangled with each other.

The non-woven fabric had physical properties as shown in Table 1.

### Example 6

Nylon 6 as used in Example 2 was used as the first fiber formable polymer, and polyethylene as used in Example 5 was used as the second fiber formable polymer. Conjugate staple fibers of 2 denier were prepared in substantially the same manner as in Example 2, except that the single orifice throughput for the spinning was 0.55 g/min, and the draw ratio was 2.6. A non-woven fabric was prepared in the same manner as in Example 2.

As a result of microscopic observation of the non-woven fabric, it was found that the split staple fibers of nylon 6 and polyethylene had a fineness of 0.2 denier per fiber. The fiber split degree was 85%, and the constituent fibers were three-dimensionally entangled with each other.

The non-woven fabric had physical properties as shown in Table 1.

The non-woven fabrics of Examples 1 to 6 were each prepared by blending water-absorptive staple fibers and split staple fibers of not greater than 0.5 denier obtained by splitting splittable bicomponent conjugate staple fibers, and densely and three-dimensionally entangling these constituent fibers with each other for integration thereof. Therefore, the non-woven fabrics were superior in mechanical properties, softness and water absorbing property. Since the constituent fibers including the micro-denier split staple fibers of not greater than 0.5 denier were densely and three-dimensionally entangled with each other for integration thereof, the non-woven fabrics each had a low breathability and, hence, an excellent filtering property. Therefore, the non-woven fabrics of Examples 1 to 6 are effectively utilized for daily necessities, garments, medical materials, hygienic materials, industrial materials, and the like.

### Comparative Example 1

Polyethylene terephthalate as used in Example 2 was used as the first fiber formable polymer, and polypropylene (melting point: 160° C., melt flow rate: 30 g/10 minutes) was used as the second fiber formable polymer. Conjugate staple fibers of 2 denier were prepared in substantially the same manner as in Example 2, except that polypropylene was melted at a temperature of 240° C., the single orifice throughput for the spinning was 0.63 g/min, and the draw ratio was 3.0. A non-woven fabric was prepared in the same manner as in Example 2.

As a result of microscopic observation of the non-woven fabric, it was found that the split staple fibers of polyethylene terephthalate and polypropylene had a fineness of 0.2 denier per fiber. The fiber split degree was 94%, and the constituent fibers were three-dimensionally entangled with each other.

The non-woven fabric had physical properties as shown in Table 1.

### Comparative Example 2

Monocomponent staple fibers composed of polyethylene terephthalate as used in Example 1 alone were used instead of the splittable bicomponent conjugate staple fibers.

More specifically, polyethylene terephthalate was melted at a temperature of 285° C., and extruded at a single orifice throughput of 0.68 g/min through a spinneret which was designed to provide a monocomponent filament having a single-phase round cross-sectional configuration by means of a melt extruder for spinning. In turn, the filament was subjected to the quenching process, the take-up process and the drawing process in the same manner as in Example 1. The draw ratio in the drawing process was 3.2. Thereafter, the filament was imparted with crimps by means of a crimping machine, and cut to a fiber length of 38 mm into 2-denier monocomponent staple fibers.

Subsequently, the monocomponent staple fibers composed of polyethylene terephthalate alone and water-absorptive bleached cotton fibers as used in Example 1 were blended in a ratio of 50/50 (wt %). A non-woven fabric was prepared in substantially the same manner as in Example 1, except for the aforesaid points.

The non-woven fabric had physical properties as shown in Table 1.

### Comparative Example 3

Bleached cotton fibers as used in Example 1 were used alone to form a 50 g/m² non-woven cotton web by means of a random carding machine. A non-woven fabric was prepared in substantially the same manner as in Example 1, except for the aforesaid point.

The non-woven fabric had physical properties as shown in Table 1.

### Comparative Example 4

Splittable bicomponent conjugate staple fibers as used in Example 1 were used alone to form a 50 g/m² non-woven web containing no water-absorptive staple fibers by means of a random carding machine. A non-woven fabric was prepared in substantially the same manner as in Example 1, except for the aforesaid point.

As a result of microscopic observation of the non-woven fabric, it was found that the splittable bicomponent conjugate staple fibers had been split for fibrillation through the high pressure liquid stream treatment, and the split staple fibers of polyethylene terephthalate and nylon 6 had a fineness of 0.2 denier per fiber. The fiber split degree was 92%.

The non-woven fabric had physical properties as shown in Table 1.

### Comparative Example 5

Polyethylene terephthalate and nylon 6 as used in Example 2 were used. A splittable bicomponent conjugate type spinneret which was designed to provide a six-segment conjugate filament having a cross-sectional configuration similar to that shown in FIG. 1 was used. The single orifice throughput for the spinning was 1.95 g/min, and the draw ratio was 3.7. The filament was cut to a fiber length of 51 mm. Thus, 5-denier conjugate staple fibers were prepared in substantially the same manner as in Example 2, except for the aforesaid points. A non-woven fabric was prepared in the same manner as in Example 2.

As a result of microscopic observation of the non-woven fabric, it was found that the splittable bicomponent conjugate staple fibers had been split for fibrillation through the high pressure liquid stream treatment, and the split staple fibers of polyethylene terephthalate and nylon 6 had a fineness of 0.8 denier per fiber. The fiber split degree was 95%.

The non-woven fabric had physical properties as shown in Table 1.

The non-woven fabric of Comparative Example 1 which employed polypropylene as one of the polymers constituting the splittable bicomponent conjugate staple fibers was superior in softness and filtering property. However, the bicomponent conjugate staple fibers were split in the carding machine during the web formation, because the compatibility of polypropylene to polyethylene terephthalate is too low. Therefore, clogging of the carding machine was liable to occur, resulting in poor operability. In addition, this non-woven fabric was inferior in water absorbing property.

The non-woven fabric of Comparative Example 2 which was produced by blending monocomponent fibers of polyethylene terephthalate having an ordinary fineness (2 denier) with the water-absorptive fibers was less dense in entanglement of the constituent fibers and exhibited a lower strength than those of Examples 1 to 6. Further, this non-woven fabric was inferior in water absorbing property, softness and air permeation resistant property (i.e., filtering property), and failed to achieve the object of the present invention.

The non-woven fabric of Comparative Example 3 which contained the cotton fibers alone as the constituent fibers was superior in water absorbing property, and suitable for use in a wet or moistened state. However, this non-woven fabric was inferior in strength, softness and filtering property to those of Examples 1 to 6, failing to achieve the object of the present invention.

The non-woven fabric of Comparative Example 4 which contained as the constituent fibers the split staple fibers alone resulting from splitting of the splittable bicomponent conjugate staple fibers was excellent in softness and draping property, because the constituent fibers were densely and three-dimensionally entangled with each other. However, this non-woven fabric was inferior in water absorbing property, failing to achieve the object of the present invention.

The non-woven fabric of Comparative Example 5 in which the split staple fibers resulting from the splitting of the splittable bicomponent conjugate staple fibers had a fineness of greater than 0.5 denier per fiber was inferior in softness and filtering property, because the three-dimensional entanglement of the constituent fibers was not dense.

1. A staple fiber non-woven fabric comprising:
first and second split staple fibers composed of first and second fiber formable polymers, respectively, and obtained by splitting splittable bicomponent conjugate staple fibers composed of the first and second fiber formable polymers; and
water-absorptive staple fibers,
wherein the first and second split staple fibers have a fineness of not greater than 0.5 denier per fiber,
wherein the first and second fiber formable polymers are different polymers selected from the group consisting of a polyamide, a polyester and a polyethylene which are incompatible with each other,
wherein a fiber split degree of the first and second split staple fibers is not lower than 85%,
wherein the first split staple fibers, the second split staple fibers and the water-absorptive staple fibers are three-dimensionally entangled with each other.

2. A staple fiber non-woven fabric as set forth in claim 1, wherein the water-absorptive staple fibers are selected from natural fibers and regenerated fibers.

3. A staple fiber non-woven fabric as set forth in claim 1, wherein the water-absorptive staple fibers are present in a proportion of 30 to 70 wt %.

4. A process for producing a staple fiber non-woven fabric, comprising the steps of:
spinning splittable bicomponent conjugate fibers composed of first and second fiber formable polymers which are different polymers selected from the group consisting of a polyamide, a polyester and a polyethylene which are incompatible with each other;
forming a non-woven web by blending the splittable bicomponent conjugate staple fibers with water-absorptive staple fibers; and
subjecting the non-woven web to a high pressure liquid stream treatment, whereby the conjugate staple fibers are split at a fiber split degree of not lower than 85% into first split staple fibers composed of the first fiber formable polymer and having a fineness of not greater than 0.5 denier per fiber and second split staple fibers composed of the second fiber formable polymer and having a fineness of not greater than 0.5 denier per fiber, and the first and second split staple fibers and the water-absorptive staple fibers are three-dimensionally entangled with each other.
